(19) United States
(12) Patent Application Publication
(10) Pub. No.: US 2015/0197176 A1
(43) Pub. Date: Jul. 16, 2015

(54) Pontoon Boat Loading Guide

(71) Applicant: Frank R. Schiller, St.Walburg (CA)

(72) Inventor: Frank R. Schiller, St.Walburg (CA)

(21) Appl. No.: 14/244,402

(22) Filed: Apr. 3, 2014

Related U.S. Application Data
(60) Provisional application No. 61/926,602, filed on Jan. 13, 2014.

(51) Int. Cl. B60P 3/10

(52) U.S. Cl. CPC B60P 3/1075

(57) ABSTRACT

An apparatus adapted to provide a loading guide for loading a pontoon boat onto a boat trailer includes a mounting plate to allow the guide to be mounted to the frame of a boat trailer and a wheel adapted to contact and guide a pontoon during loading. The wheel includes a center axis and a tire. The wheel center axis is mounted vertically so that the pontoon body will come in contact with the outer surface of the tire and the wheel will rotationally guide the pontoon down its length as the boat is loaded. A plurality of these guides are mounted on the boat trailer to provide a system of loading guides for optimum support of the pontoon boat during loading and unloading.

### RELATED APPLICATIONS

The present invention is a continuation-in-part of and claims the benefit of U.S. Provisional Application No. 61/926,602, filed Jan. 13, 2014, the entire disclosures of which are incorporated herein by reference.

### FIELD OF THE INVENTION

The present invention relates generally to a guide and system of guides for loading and unloading a pontoon boat onto a boat trailer.

### BACKGROUND OF THE INVENTION

A common style of boat for basic general boating is that of the pontoon boat. They have many benefits, especially when large amounts of people are involved. They have plenty of room for entire families and friends. They also have a large amount of storage space for things like ice chests, food, towels, tackle, personal bags, and the like. They are easily to pilot, have a relatively low draft for shallow locations, and are almost impossible to tip over as people move or walk around. However, pontoon boats suffer from the fact that they are somewhat difficult to load onto transport trailers. While pontoon boat trailers will typically have guide rods in place, they are somewhat difficult to see in rough water. Also, should the rods contact the pontoons themselves; damage that is expensive to repair is the likely result. Accordingly, there exists a need for a means by which pontoon boats can be more easily loaded onto trailers, without the disadvantages as listed above.

### SUMMARY OF THE INVENTION

The disadvantages of the prior art are overcome by the present invention in providing a post having a distal end operatively affixed to a boat trailer and a wheel assembly axially and rotatively mounted to a proximate end of the post. The outer circumferential surface of the wheel assembly contacts and rotatively guides a surface of a boat during loading and unloading events on and off the trailer. The use of the present invention provides the ability to load and unload pontoon boats from a trailer, in a manner that is not only quick, easy, and effective, but safe and damage free as well.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of a boat loading guide 10, according to a preferred embodiment of the present invention;

FIG. 2 is an exploded view of the boat loading guide 10, according to a preferred embodiment of the present invention; and,

FIG. 3 is an environmental view of the boat loading guide 10 depicting a plurality of units being mounted to an existing boat trailer frame 100, according to a preferred embodiment of the present invention.

### DESCRIPTIVE KEY

10 boat loading guide

12 plurality of guides

20 wheel assembly

22 hub

23 axial mounting aperture

24 tire

30 post

32 shaft

33 threaded aperture

34 thrust washer

36 weld

40 mounting plate

42 fastener aperture

80 retaining bolt

81 nut fastener

82 retaining washer

84 “U”-bolt

100 trailer frame

110 pontoon

### DETAILED DESCRIPTION OF THE PREFERRED EMBODIMENT

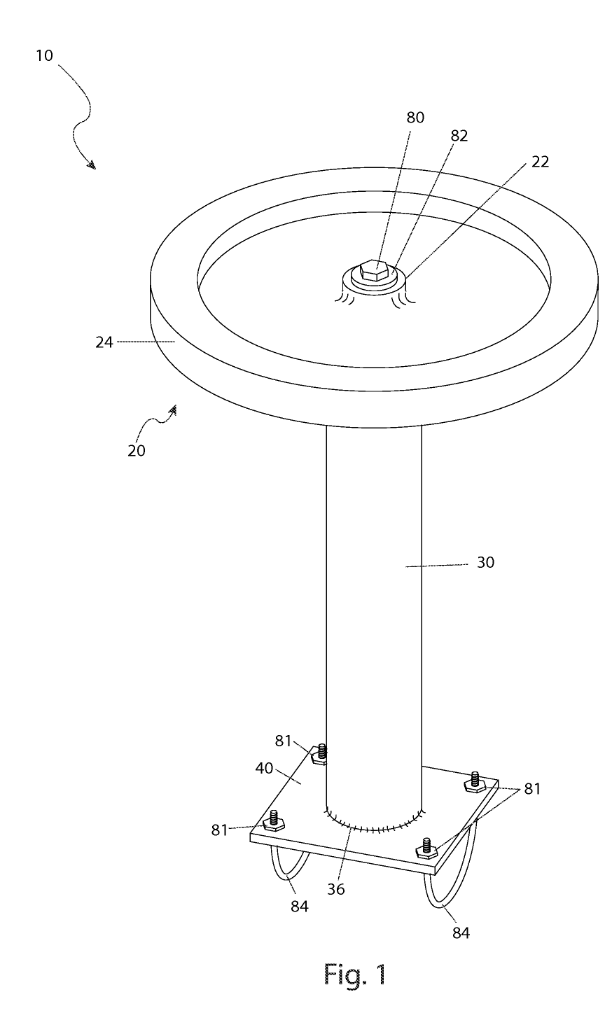

The best mode for carrying out the invention is presented in terms of its preferred embodiment, herein depicted within FIGS. 1 through 3. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

The terms “a” and “an” herein do not denote a limitation of quantity, but rather denote the presence of at least one of the referenced items.

The present invention describes a boat loading guide (herein described as the “apparatus”) 10, which is mounted along a frame portion 100 of an existing boat trailer to protectively aid in loading or unloading a boat from the trailer. The apparatus 10 is envisioned to be especially beneficial for pontoon-type boats due to the fragile nature of a pontoon 110. Further, while the apparatus description to follow relates to an individual boat guide 10, in application, a plurality of guides 12 are utilized as a system wherein each guide may be individually positioned at predetermined positions about a boat trailer frame 100 as required to provide a guided movement of a boat on and off a trailer. The plurality of guides as a system 12 is also adaptable for use with other types of watercraft.

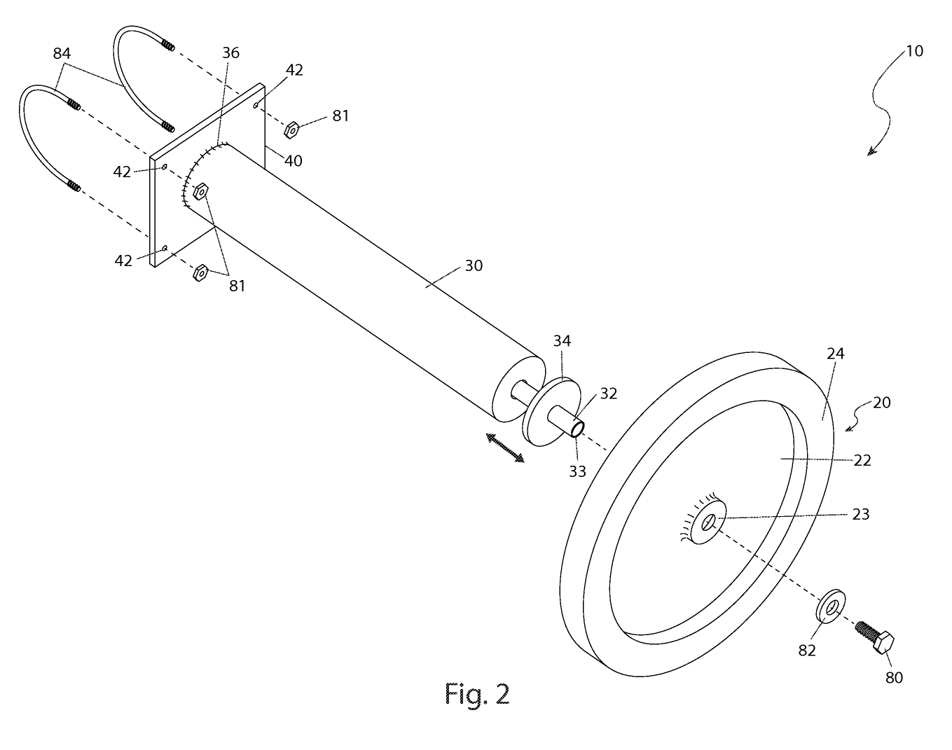

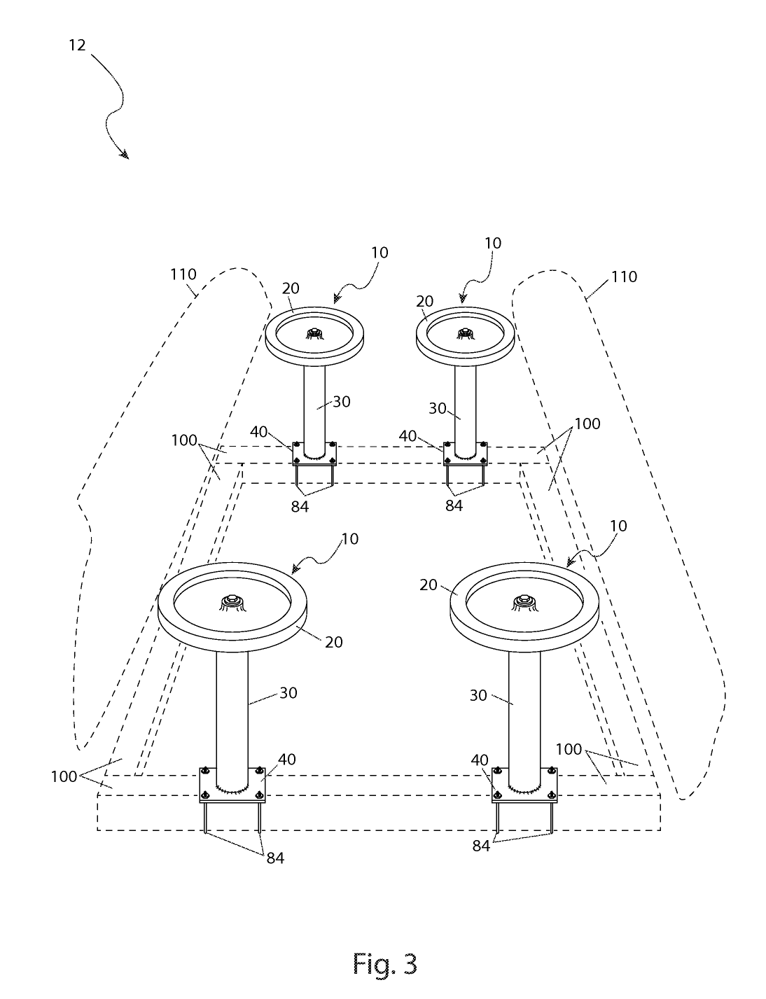

Referring now to FIGS. 1 and 2, perspective and exploded views of the apparatus 10, according to the preferred embodiment of the present invention, are disclosed. The apparatus 10 includes a wheel assembly 20 having a center axial mounting aperture 23 and a tire 24. The wheel assembly 20 is operatively disposed on a first, or proximate end of a post 30. In the preferred manner of use, the wheel assembly 20 is positioned in a horizontal orientation, with the post 30 generally set vertically in reference to an associated boat trailer 100 (see FIG. 3) so as to cushion and guide a side surface of a pontoon 110 of a pontoon boat during loading and unloading tasks. In the preferred embodiment, the wheel assembly 20 includes a pneumatic inflatable tire 24, however a solid tire may be alternately utilized.

The second, or distal end of each post 30 is attached by a weld 36 in a perpendicular manner to a rectangular mounting plate 40. The mounting plate 40 includes a fastener aperture 42 at each corner location to enable attachment of the mounting plate 40 to portions of the frame 100 of a boat trailer using a pair of “U”-bolts 84 with corresponding nut fasteners 81. It should be appreciated that without limitation, rather than employing the bolts and fasteners 84 and 81, the mounting plate 40 may be operatively affixed to the boat frame 100 by welding. Given a generally standardized dimensional profile of pontoon boats currently produced, one particular embodiment of the apparatus 10 is envisioned to provide a post 30 which is approximately fourteen inches (14 in.) in height and one-and-one-half inches (1-½ in.) in diameter; however, it is understood that the post 30 may be introduced in various heights and sizes based upon a size and type boat trailer the apparatus 10 is to be installed upon and variations in the boat dimensions.

The top portion of the post 30 provides features upon which the axial mounting aperture 23 of the hub 24 of the wheel assembly 20 is rotatingly attached. The post 30 includes an axle-like shaft 32 having a thrust washer 34 disposed thereupon, with a threaded aperture 33 machined into the axial end surface of the shaft 32. The shaft 32 is sized so as to be slidingly inserted into the axial mounting aperture 23 when the wheel assembly 20 is placed upon the shaft 32. The wheel assembly 20 is rotationally secured onto the post 30 by installing a retaining washer 82 upon a protruding portion of the shaft 32 and threadingly engaging a retaining bolt 80, such as a shoulder bolt, into the aforementioned threaded aperture 33. The wheel assembly 20 is envisioned to comprise a standard-sized pneumatic rubber tire being approximately twelve inches (12 in.) in diameter, being similar to those utilized upon small utility trailers.

Referring now to FIG. 3, an environmental view of the system 12 incorporating a plurality of apparatuses 10 units is shown with the guides 10 being mounted to an existing boat trailer frame 100 in predetermined positions, according to a preferred embodiment of the present invention, is disclosed. It is envisioned that a plurality of apparatus guides 10 would be mounted upon parallel lateral portions of a trailer frame 100 so as to enable selective lateral positioning based upon a distance between the pontoons 110 of an existing boat, thus positioning each wheel assembly 20 at a suitable distance from the pontoon 110 so as to cushion and guide opposing pontoon portions 110 during boat loading and unloading events. These features allow for safe and guided loading and unloading of a pontoon boat onto or off of a trailer even during times of rough water. As the pontoon 110 contacts the apparatus 10, the “soft” nature and rotation of the wheel assembly 20, reduces a risk of damage to the pontoon 110.

It is envisioned that other styles and configurations of the present invention can be easily incorporated into the teachings of the present invention, and only one particular configuration shall be shown and described for purposes of clarity and disclosure and not by way of limitation of scope.

The preferred embodiment of the present invention can be utilized by the common user in a simple and effortless manner with little or no training. After initial purchase or acquisition of the apparatus 10, it would be installed as indicated in FIG. 3.

The method of installing and utilizing the apparatus 10 may be achieved by performing the following steps: procuring a required number of units of the apparatus 10 having a post 30 of a desired height, and wheel assembly 20 having a desired diameter; assembling the wheel assembly 20 to the shaft 32 by installing the thrust washer 34, wheel assembly 20, retaining washer 82, and retaining bolt 80, if not previously assembled; positioning an apparatus 10 along a lateral member of the boat trailer frame 100; positioning a perimeter portion of the wheel assembly 20 so as to form a small gap to an inner surface of a pontoon 110; installing a pair of “U”-bolts 84 around the frame 100 and up through the fastener apertures 42 in the mounting plate 40; securing the “U”-bolts 84 by installing and tightening corresponding nut fasteners 81 upon threaded portions of the “U”-bolts 84; repeating the positioning and “U”-bolt 84 installation steps for the remaining units of the apparatus 10; loading and unloading a pontoon boat, or similar water vessel, in a normal manner; and, benefiting from improved protection of pontoons 110 afforded a user of the present invention 10.

The apparatus 10 may also provide protection to other styles of watercraft by positioning units of the apparatus 10 at various positions along a boat trailer frame 100 as required to provide similar protection to exposed surfaces of the watercraft.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. A boat loading guide, comprising:
a post having a distal end;
a plate welded to said distal end, said plate having four apertures;
a first “U” bolt passing through a first two of said four apertures;
a second “U” bolt passing through a second two of said four apertures; and
a wheel assembly axially and rotatively mounted to a proximate end of said post;
wherein an outer circumferential surface of said wheel assembly is adapted to contact and rotatively guide a surface of a boat during loading and unloading events of said trailer; and
wherein said first “U” bolt and said second “U” bolt are for attaching said boat loading guide to a trailer.

2. The loading guide of claim 1, wherein said post further comprises an axle shaft extending from a proximate end, and wherein said wheel assembly is axially and rotatively mounted to said axle shaft of said post.

3. The loading guide of claim 2, wherein said wheel assembly further comprises:
a hub having an axial mounting aperture rotatively disposed on said axle shaft of said post; and,
a tire operatively mounted to an outer circumference of said hub.

4. The loading guide of claim 3, wherein said tire further comprises a pneumatically inflatable tire body.

5. The loading guide of claim 1, wherein said post further comprises a mounting plate operatively affixed to said distal end, wherein said mounting plate is affixed to said trailer.

6-7. (canceled)

8. The loading guide of claim 2, wherein said post further comprises:
a threaded aperture formed in an axial end of said axle shaft;
a thrust washer operatively disposed on said axle shaft;
a retaining washer operatively disposed on said axle shaft;
a wheel assembly mounted on axle shaft between said thrust washer and said retaining washer; and,
an axle bolt operatively threaded into said threaded aperture;
wherein said axle bolt operatively retains said thrust washer, said wheel assembly, and said retaining washer on said axle shaft.

9. A boat loading guide, comprising:
a post having a distal end operatively affixed to a boat trailer by a mounting plate welded to said post and two “U” bolts that pass though said mounting plate;
a hub axially and rotatively mounted to a proximate end of said post; and,
a tire operatively mounted to an outer circumference of said hub;
wherein an outer circumferential surface of said tire is adapted to contact and rotatively guide a surface of a boat during loading and unloading events of said trailer.

10. The loading guide of claim 9, wherein said tire further comprises a pneumatically inflatable tire body.

11-12. (canceled)

13. The loading guide of claim 9, wherein said distal end of said post is operatively fixed to said mounting plate by a welding operation.

14. The loading guide of claim 9, wherein said post further comprises:
an axle shaft extending from said proximate end of said post;
a threaded aperture formed in an axial end of said axle shaft;
a thrust washer operatively disposed on said axle shaft;
a retaining washer operatively disposed on said axle shaft;
a wheel assembly mounted on axle shaft between said thrust washer and said retaining washer; and,
an axle bolt operatively threaded into said threaded aperture;
wherein said axle bolt operatively retains said thrust washer, said wheel assembly, and said retaining washer on said axle shaft.

15. A boat loading guide system, comprising:
a plurality of boat loading guides each individually disposed about the frame of a boat trailer in predetermined positions, each said boat loading guide further comprising:
a post having a distal end operatively affixed to said trailer by a mounting plate welded to said post and two “U” bolts that pass through said mounting plate and a proximate end having an axle shaft extending therefrom; and,
a wheel assembly axially and rotatively mounted to said axle shaft of said post;
wherein an outer circumferential surface of each said wheel assembly of said plurality of guides is adapted to contact and rotatively guide a surface of a boat during loading and unloading events of said trailer.

16. The system of claim 15, wherein each said wheel assembly further comprises:
a hub having an axial mounting aperture rotatively disposed on said axle shaft of said post; and,
a tire operatively mounted to an outer circumference of said hub.

17. The system of claim 15, wherein each said tire further comprises a pneumatically inflatable tire body.

18-19. (canceled)

20. The system of claim 15, wherein each said post further comprises:
a threaded aperture formed in an axial end of said axle shaft;
a thrust washer operatively disposed on said axle shaft;
a retaining washer operatively disposed on said axle shaft;
a wheel assembly mounted on axle shaft between said thrust washer and said retaining washer; and,
an axle bolt operatively threaded into said threaded aperture;
wherein said axle bolt operatively retains said thrust washer, said wheel assembly, and said retaining washer on said axle shaft.
